(19) United States
(12) Patent Application Publication
(10) Pub. No.: US 2020/0037582 A1
(43) Pub. Date: Feb. 6, 2020

(54) HIDEAWAY PET RAMP

(71) Applicant: KEEVER GEAR, LLC, Bellevue, WA (US)

(72) Inventors: Thomas J. Caterson, Bellevue, WA (US); William A. Anderson, Seattle, WA (US); Barrett Estep, Seattle, WA (US); Justin M. Knowles, Seattle, WA (US)

(73) Assignee: KEEVER GEAR, LLC, Bellevue, WA (US)

(21) Appl. No.: 16/526,559

(22) Filed: Jul. 30, 2019

Related U.S. Application Data
(60) Provisional application No. 62/764,420, filed on Aug. 3, 2018.

(51) Int. Cl. A01K 29/00; E04F 11/00; A47C 21/00

(52) U.S. Cl. CPC A01K 29/00; E04F 2011/005; A47C 21/00; E04F 11/002

(57) ABSTRACT

Hideaway pet ramps of the present disclosure are collapsible, discreet, and greatly facilitate access for pets onto beds, sofas, vehicles, and other elevated areas. This access can be greatly beneficial for infirm, geriatric, overweight, and small pets. Advantageously, pet ramps of the present disclosure also reduce the likelihood of injury for pet owners, such as injuries from lifting an animal onto the bed without the benefit of a ramp. Pet ramps of the present disclosure generally include a thin, rigid housing that discreetly fits underneath a mattress without compromising the comfort of the mattress. The housing forms a pocket configured to store a telescoping, height-adjustable and length-adjustable ramp assembly having an upper slide assembly and a lower slide assembly that may be deployed at any time a pet needs access to/from the bed.

### CROSS-REFERENCE TO RELATED APPLICATION

This application claims the benefit under 35 U.S.C. § 119(e) of U.S. Provisional Patent Application No. 62/764,420, filed Aug. 3, 2018, the entirety of which is incorporated by reference herein.

### SUMMARY

Decor-minded pet owners want a discreet solution for their pets to climb onto the bed. Not only are bulky ramps and stairs designed for permanent placement beside the bed unsightly, but they also interfere with regular usage of the bed.

The present disclosure provides ramps that are discreet, yet greatly facilitate access for pets onto beds, sofas, vehicles, and other elevated areas. This access can be greatly beneficial for infirm, geriatric, overweight, and small pets. Advantageously, pet ramps of the present disclosure also reduce the likelihood of injury for pet owners, such as injuries from lifting an animal onto the bed without the benefit of a ramp.

Pet ramps of the present disclosure generally include a thin, rigid housing that discreetly fits underneath a mattress (and in most cases, between the mattress and a box spring) without compromising the comfort of the mattress. The housing forms a pocket configured to store a telescoping, height-adjustable and length-adjustable ramp assembly having an upper slide assembly and a lower slide assembly that may be deployed at any time a pet needs access to/from the bed. The deployed ramp assembly may be locked in place, such as after setting the desired height. The user may, at some later time, stow the ramp assembly within the pocket. Embodiments of the pet ramp may have one or more features to increase its utility, including a height adjustment mechanism on one or more vertical members and/or legs, a position-locking mechanism to increase stability and to facilitate setup, a grippy walking surface, one or more guide members that help pets identify the edges of the ramp and/or the top of the ramp or mattress through visual or tactile identification of the ramp edges, additional legs, a bridge to cover the gap between the ramp and the bed, and other features. These features are merely exemplary, and are not intended to limit the scope of the present disclosure.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a perspective view of a pet ramp in accordance with the present disclosure, in a deployed configuration;

FIG. 2 shows a partial perspective view of the pet ramp of FIG. 1;

FIG. 3 shows another partial perspective view of the pet ramp of FIG. 1;

FIG. 4 shows a partial section view of an aspect of a housing assembly and a vertical member assembly of the pet ramp of FIG. 1;

FIG. 5 shows another perspective view of the pet ramp of FIG. 1, in a stowed configuration;

FIG. 6 shows a partial perspective view of a vertical member assembly, an upper slide assembly, and a lower slide assembly of the pet ramp of FIG. 1;

FIG. 7 shows an end view along the upper slide assembly of the pet ramp of FIG. 1; and

FIG. 8A shows a left side section view of the pet ramp of FIG. 1 in a stowed state;

FIG. 8B shows a left side view of the pet ramp of FIG. 1 in a partially deployed state;

FIG. 8C shows a left side view of the pet ramp of FIG. 1 in another partially deployed state; and

FIG. 8D shows a left side view of the pet ramp of FIG. 1 in the deployed state.

One skilled in the relevant art will appreciate that elements in the figures may be illustrated for simplicity and clarity and have not necessarily been drawn to scale. For example, the dimensions of some of the elements in the figures may be exaggerated relative to other elements to make various embodiments of the present disclosure easily understood. Also, common but well-understood elements that are useful or necessary in a commercially feasible embodiment are often not depicted in order to highlight the key features of these various embodiments of the present disclosure.

### DETAILED DESCRIPTION

Examples of devices, systems, and methods are described herein to describe various embodiments of pet ramps. In the following description, numerous specific details are set forth to provide a thorough understanding of the examples. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

References throughout this specification to “one example” or “one embodiment” or the like means that a particular feature, structure, or characteristic described in connection with the example is included in at least one example of the present disclosure. Thus, the appearances of the phrases “in one example” or “in one embodiment” in various places throughout this specification are not necessarily all referring to the same example. Furthermore, the particular features, structures, or characteristics may be combined in any suitable manner in one or more examples. Further, references to “left,” “right,” “upper,” “lower,” etc. are intended to facilitate communication, and not intended to limit the scope of the present disclosure. Further still, in this disclosure, the term “about” indicates +/−5% of the stated value.

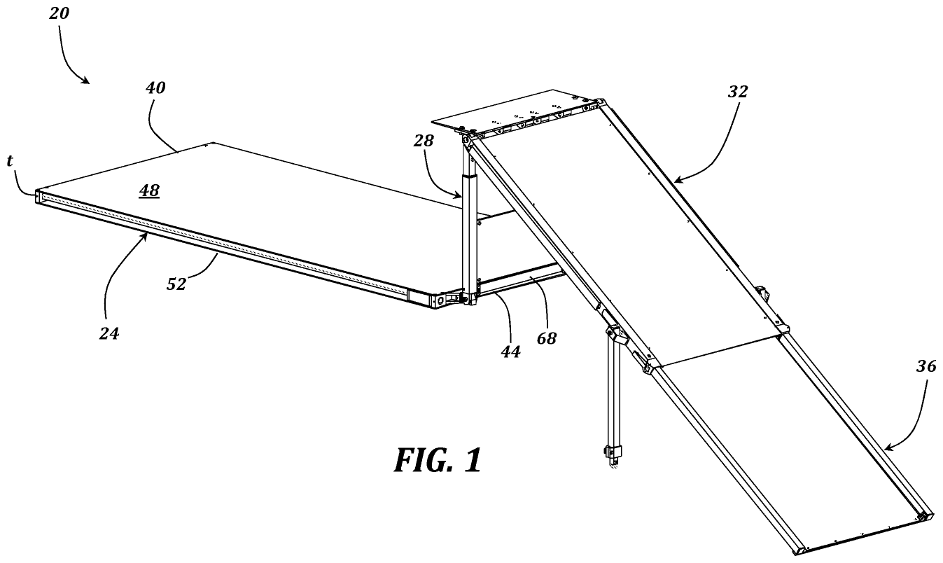

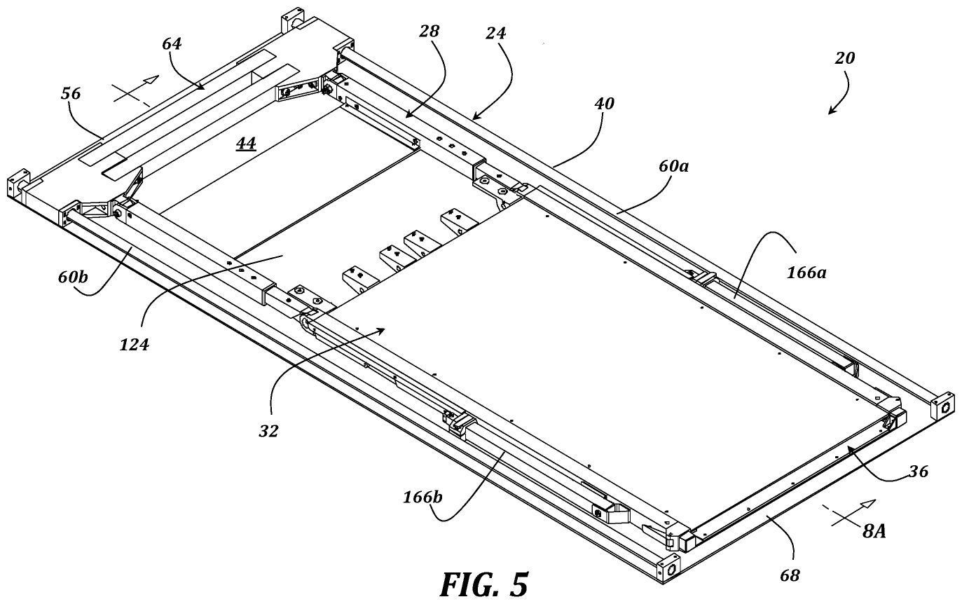

FIG. 1 shows a pet ramp 20 of the present disclosure. The pet ramp 20 is movable between a deployed state (as shown in FIG. 1) and a stowed state (as shown in FIG. 5). In the deployed state, the pet ramp 20 may have numerous different specific configurations to facilitate pet access onto a bed. In the stowed state, the pet ramp 20 is generally stowed underneath a mattress, such as between a mattress and a box spring.

Although the term “pet” is used throughout this disclosure to facilitate understanding, that term is not intended to limit the scope of the present disclosure to domesticated animals, or to animals at all. The pet ramp 20 may be equally useful for other animals, or for entirely non-animal purposes. Moreover, the pet ramp 20 is frequently discussed herein in the context of a bed (specifically, a mattress) to facilitate understanding; however, again, that application is exemplary and is not intended to limit the scope of the present disclosure to such applications. Indeed, the pet ramp 20 may be equally useful in other applications that do not involve a bed.

The pet ramp 20 includes four main assemblies: a housing assembly 24, a vertical member assembly 28, an upper slide assembly 32, and a lower slide assembly 36. Some embodiments may not include the lower slide assembly 36, but may instead have a single slide assembly. Together, the aforementioned assemblies enable the pet ramp 20 to move between the stowed state and the deployed state, and to adjust for a number of different bed heights, mattress heights, room sizes, and other application-specific constraints.

FIG. 1 shows the housing assembly 24, which generally includes a solid outer housing 40 that at least partially defines a pocket 44. The housing 40 may be constructed from metal (e.g., aluminum), plastic (e.g., ABS plastic), and/or other suitable rigid material(s) that retains sufficient structurally integrity when the weight of a mattress and one or more humans and pet(s) bear down on it, such that the housing 40 does not compress so much that the vertical member assembly 28, upper slide assembly 32, and lower slide assembly 36 cannot slide into and out of the pocket 44.

The housing 40 of the illustrated embodiment includes a top surface 48 and a bottom surface 52. Although the housing 40 of the illustrated embodiment is formed from an upper half and a lower half, in other embodiments, the housing 40 may be formed from a single component, from a greater number of components, or from two components having different construction from the illustrated embodiment (e.g., a front and a rear half). When viewed from above (i.e., from above a bed), the housing 40 has a rectangular shape, although other embodiments may have alternative shapes from that perspective. Because the illustrated embodiment may be utilized underneath a mattress, the housing 40 has dimensions that are smaller than a typical mattress. In the non-limiting illustrated embodiment, the housing 40 has a width of about 2 feet and a length of about 5 feet. In other embodiments, for example embodiments designed for use underneath a sofa cushion, in a vehicle, or in another application, the width and/or length of the housing may be greater or lesser than the illustrated embodiment. In embodiments suitable for use under a mattress such as the illustrated embodiment, the housing should not undermine the comfort of the mattress above it or otherwise disturb the sleep patterns of its users. The inventors have discovered in testing that when the housing 40 has a thickness t of less than about 2 inches (e.g., less than about 1.5 inches, less than about 1⅜ inches, less than about 1¼ inches, less than about 1 inch, or less), it does not undermine the comfort of the mattress above it. Accordingly, the specific configurations and dimensions described herein may be instrumental to reducing the overall thickness of the pet ramp 20 in the stowed state. Consistent with the goal to not disturb user sleep patterns, the top surface 48 and the bottom surface 52 should be substantially flat, but may have a texture or other subtle features that do not meaningfully affect the overall thickness t of the housing 40.

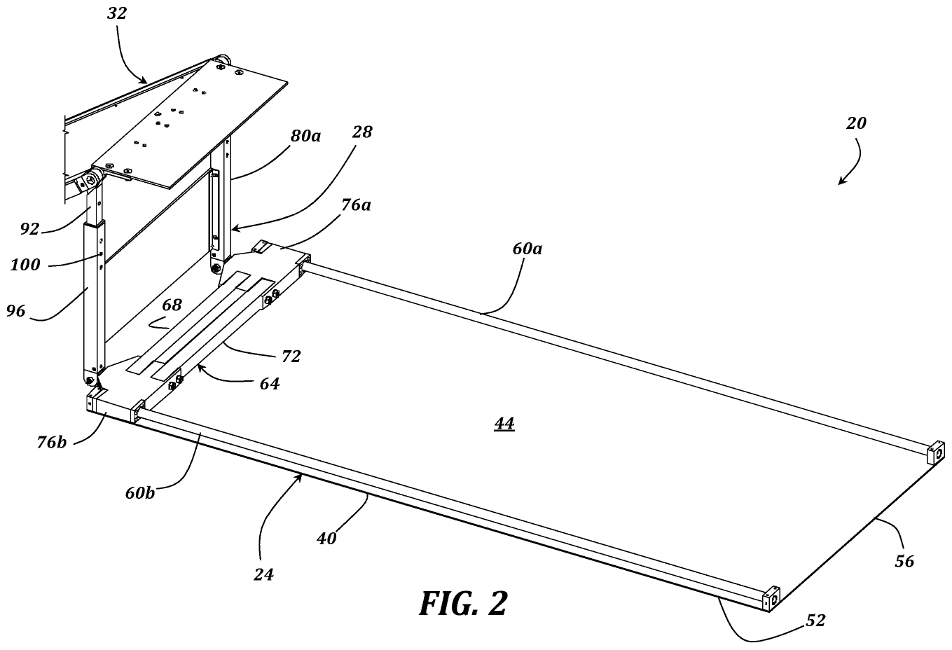

FIG. 2 shows the housing assembly 24, with the pet ramp 20 in the deployed state and with the top surface 48 of the housing 40 hidden. It can be seen that the housing assembly 24 contains two rails 60a, 60b that run parallel to each other and also parallel to the bottom surface 52. The housing assembly 24 also includes a carriage 64 that is coupled with the vertical member assembly 28, and is configured to slide along the rails 60a and 60b. In the deployed state shown in FIGS. 1-3, the carriage 64 is located proximal to an opening 68 of the pocket 44. In the stowed state (described below with respect to FIG. 5), the carriage 64 is located proximal to a rear side 56 of the pocket 44. In some embodiments, a portion of the housing 40 that surrounds the opening 68 (i.e., an outer edge) may be covered, coated, treated, or fitted with a material (such as a foam or silicone trim piece) having a soft, touch-friendly material that prevents injury when utilizing the pet ramp 20.

The carriage 64 includes a central frame 72 that substantially spans the two rails 60a, 60b. At opposing ends of the central frame 72 are two end units 76a and 76b, each having an aperture therethrough that is sized to receive the rails 60a and 60b, respectively, such that the end units 76a and 76b may slide along the rails 60a and 60b. To facilitate this sliding movement, the end units 76a and 76b include a one or more optional bushings having a low coefficient of friction with the material(s) of rails 60a and 60b. In an embodiment, the end units 76a and 76b may include one or more bearings in addition to (or instead of) bushings to further ease this sliding action. In an embodiment, the end units 76a and 76b may be at least partially formed from a material having a low coefficient of friction with the rails 60a and 60b. Although the illustrated embodiment utilizes a rail-and-sliding carriage structure to guide movement of various components of the pet ramp 20 into and out of the pocket 44, other embodiments may utilize other structures, such as a rack-and-pinion structure.

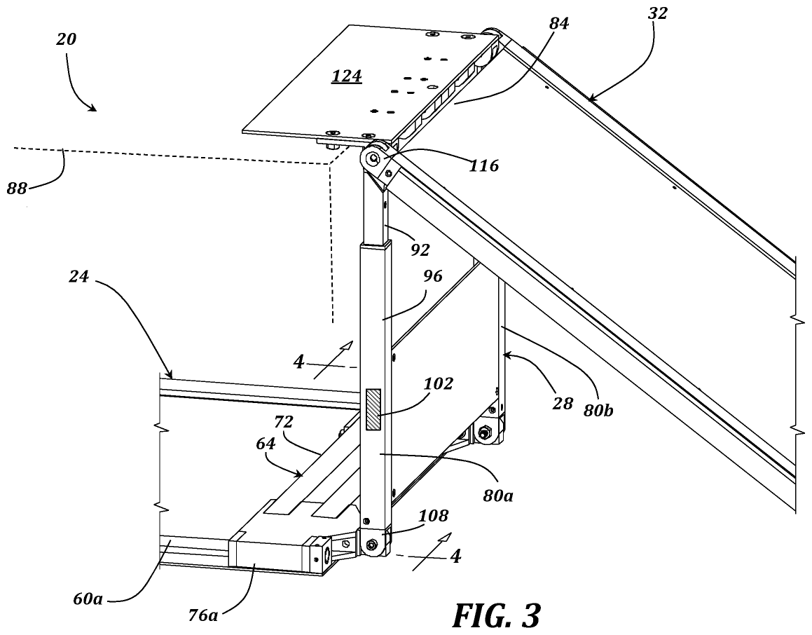

FIG. 3 further shows the connection between the housing assembly 24 and the vertical member assembly 28, with the top surface 48 of the housing 40 hidden (as in FIG. 2). The vertical member assembly 28 includes a plurality of height adjustment members 80a, 80b that each pivotably couple to the central frame 72. The vertical member assembly 28 generally supports a mattress-facing end 84 of the upper slide assembly 32 at a height that facilitates pet ingress and egress from a mattress 88. The term “vertical” is used herein to facilitate understanding, and is not intended to limit the disclosure to embodiments with structure that forms a right angle relative to the housing assembly 24. Although the vertical member assembly 28 forms a right angle with the housing assembly 24 in the illustrated embodiment, in other embodiments, the vertical member assembly 24 need not form a right angle. Rather, in some embodiments, the vertical member assembly may be configured to have a non-vertical position that supports the upper slide assembly (i.e., a non-90 degree position, such as any angle between about 45 degrees and about 135 degrees, e.g., between about 75 degrees and about 105 degrees). Although the term “mattress-facing” is utilized throughout this disclosure, that term is not intended to limit the application of ramps to beds; rather, ramps of the present disclosure are equally applicable to sofa, chairs, vehicles, and other applications.

As noted above, the vertical member assembly 28 of the illustrated embodiment includes a plurality of height adjustment members 80a, 80b. Some embodiments may include a single height adjustment member 80. Each height adjustment member 80a, 80b includes an upper member 92 that telescopically adjusts relative to a lower member 96 in order to adjust the height of the mattress-facing end 84 of the upper slide assembly 32. Referring again to FIG. 2, a height setting mechanism 100 enables the upper member 92 to remain at the desired height relative to the upper member 92. In the illustrated embodiment, the height setting mechanism 100 utilizes a spring-biased button located on the upper member 92 that reversibly protrudes through one of a plurality of height setting apertures located within the lower member 96. In other embodiments, the height setting mechanism can have a different configuration, e.g., a cam lock or comparable mechanism.

Referring again to FIG. 3, the vertical member assembly 28 further includes a position release button 102 that is configured to release a vertical position lock (discussed below). Although the illustrated embodiment includes a position release button 104, it shall be appreciated that other embodiments may utilize a lever, knob, pull tab, or other mechanism that is configured to release the vertical position lock, instead of a button. In the illustrated embodiment, the position release button 102 is located on the vertical member 80a, but may be located elsewhere in other embodiments. A lower end of the lower member 96 includes a receiver 108 that pivotably couples with the carriage 64. In the illustrated embodiment, the lower member 96 couples with the corresponding end unit 76, but in other embodiments may couple with the central frame 72. This pivotal connection enables the height adjustment members 80a, 80b to exhibit at least a 90 degree range of motion relative to the housing assembly 24. In the deployed state, the height adjustment members 80a, 80b and the housing assembly 24 form a right angle, although in other embodiments the exact angle may vary, e.g., may form a 45 degree angle, an 85 degree angle, a 95 degree angle, a 135 degree angle, between about 75 degrees and about 105 degrees, including any angle in between, etc. In the illustrated embodiment, the receiver 108 and the carriage 64 include complementary protrusions and apertures to pivotably couple the lower member 96 to the carriage 64. Some embodiments may have one or more separate axles to pivotably couple the lower member 96 to the carriage 64.

Similar to the pivotal connection between the lower member 96 and the carriage 64, a receiver 116 located at the mattress-facing end 84 of the upper slide assembly 32 pivotably connects with an upper end of the upper member 92. This pivotable connection enables a user to place the upper slide assembly 32 and the lower slide assembly 36 at the desired slope. To further facilitate pet ingress and egress from an elevated surface (e.g., the mattress 88), a bridge 124 is configured to cover the gap between the elevated surface and the upper slide assembly 32. The bridge 124 is pivotably coupled with the upper slide assembly 32 such that it may be pivoted to a position that allows it to rest on top of the elevated surface. Advantageously, linens and other bedding may be tucked underneath the bridge 124.

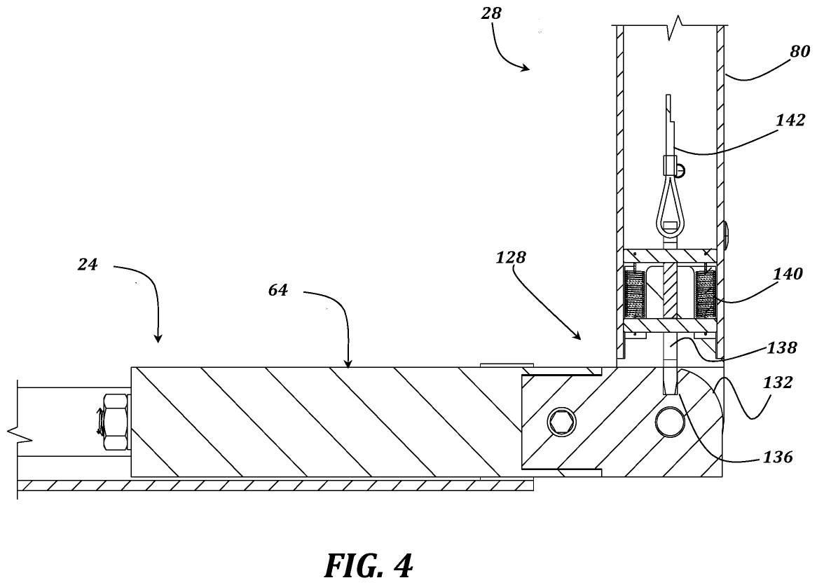

FIG. 4 shows a section view taken along section line shown in FIG. 3, to show details of a vertical position lock 128 that locks the vertical member assembly 28 at about a right angle relative to the housing assembly 24 (i.e., when the height adjustment members 80 are in a vertical position relative to the housing 40). As stated above, in other embodiments, the vertical position lock may lock the vertical member assembly at another angle relative to the housing assembly. In this way, the vertical position lock 128 facilitates deployment of the pet ramp 20 from the stowed state to the deployed state, and increases safety during use. The vertical position lock 128 includes components in the vertical member assembly 28 and the housing assembly 24. In the housing assembly 24, the carriage 64 includes at least one rounded mating surface 132 that has a slot 136 formed therein. In the vertical member assembly 28, at least one height adjustment member 80 includes a pin 138 that is biased toward the rounded mating surface 132 of the carriage 64. Springs 140 provide the biasing force in the illustrated embodiment, although equivalent force-providing mechanisms may be utilized in other embodiments.

In use, when the pet ramp 20 is moved from the stowed state to the deployed state, the height adjustment member 80 rotates relative to the housing assembly 24. When the height adjustment member 80 forms a ninety degree angle with the housing assembly 24 (i.e., is in the vertical position), the pin 138 aligns with the slot 136, and the springs 140 cause the pin 138 to engage the slot 136. Thus, the vertical member assembly 28 is locked in the vertical position relative to the housing 40. To release the vertical member assembly 28 from the vertical position, the user activates the position release button 102 (see FIG. 3), thereby pulling the pin 138 out of the slot 136 against the biasing force of the springs 140. In the illustrated embodiment, the position release button 102 is connected to the pin 138 by a cable 142; however, the position release button 102 may have a different connection in other embodiments.

FIG. 5 shows the pet ramp 20 in the stowed state, with the bottom surface 52 of the housing 40 hidden, along with a portion of the upper slide assembly 32. It can be seen that all of the major components of the pet ramp 20 are stowed within the pocket 44 of the housing assembly 24 as a result of the movement of the carriage 64 to the rear side 56 of the pocket 44. Moving from the rear side 56 of the pocket 44 toward the opening 68 of the pocket 44, the carriage 64 joins with the vertical member assembly 28, which in turn joins with the upper slide assembly 32. The lower slide assembly 36 is nested within the upper slide assembly 32. Thus, each of the vertical member assembly 28, the upper slide assembly 32, and the lower slide assembly 36 are stowed completely within the pocket 44, in between the rails 60a and 60b. In this stowed configuration, the entire pet ramp 20 may be stored discreetly.

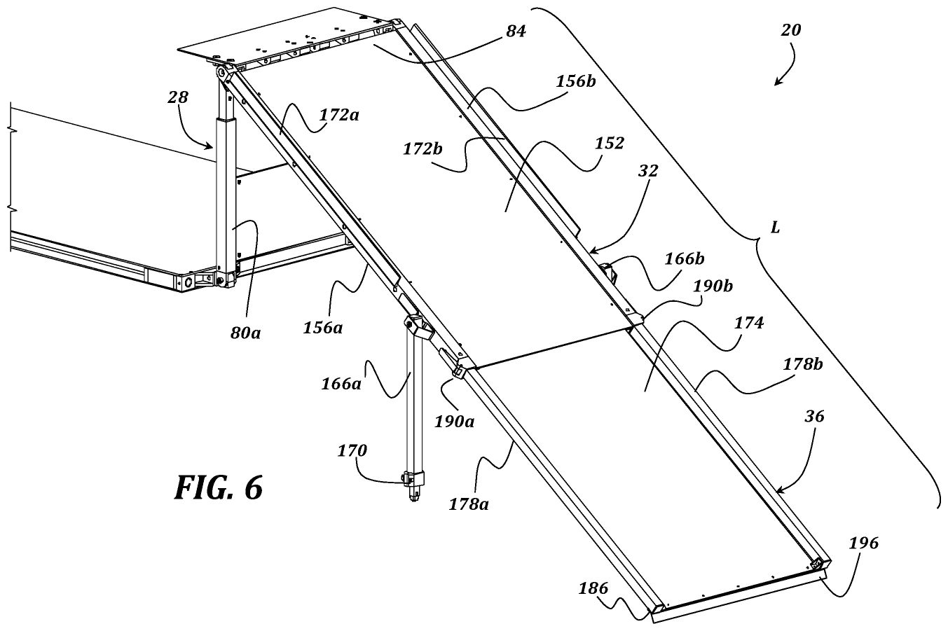

FIG. 6 shows additional details of the vertical member assembly 28 and the upper slide assembly 32. As described above, the mattress-facing end 84 of the upper slide assembly 32 pivotably connects with the height adjustment member 80a (and 80b, not shown), to enable a user to place the upper slide assembly 32 and the lower slide assembly 36 at the desired slope.

The upper slide assembly 32 comprises an upper pan 152, a left tube 156a coupled to a left side of the upper pan 152, and a right tube 156b coupled to a right side of the upper pan 152. The upper pan 152 serves as a walking surface for pets ingressing/egressing the bed, while the left and right tubes 156a, 156b form part of a telescoping assembly that enables the lower slide assembly 36 to slide relative to the upper slide assembly 32. This telescopic sliding movement is described in further detail below. In the illustrated embodiment, the upper pan 152 is formed of metal (e.g., sheet metal), but in other embodiments may be formed of one or more other materials (e.g., ABS plastic). The left and right tubes 156a, 156b have a square cross section in the illustrated embodiment, but may have a circular or other cross section in other embodiments.

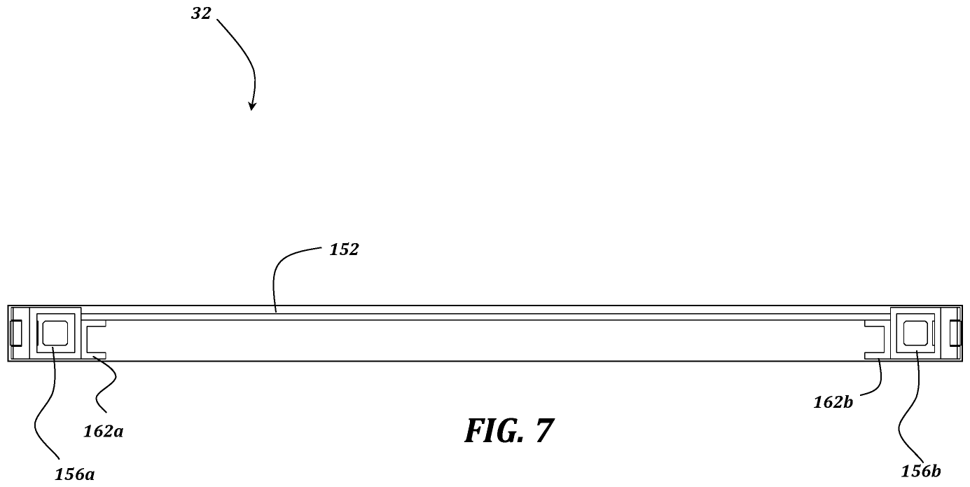

FIG. 7 shows an end view along the upper slide assembly 32, with the housing assembly 24, vertical member assembly 28, and lower slide assembly 36 hidden. A left angle bracket 162a and a right angle bracket 162b are located adjacent with the inward-facing sides of the left tube 156a and the right tube 156b, respectively, and also adjacent to a bottom side of the upper pan 152. In the illustrated embodiment, the left angle bracket 162a and the right angle bracket 162b are coupled with the left tube 156a and the right tube 156b, respectively, but may additionally or alternatively be coupled with the upper pan 152 in other embodiments. The angle brackets 162a, 162b and the bottom side of the upper pan 152 together form a track that is configured to slidably receive a portion of the lower slide assembly 36, as described below.

Referring to FIG. 6 again, the upper slide assembly 32 further includes a plurality of optional support legs 166a, 166b that further support the weight of pets utilizing the pet ramp 20. Embodiments having optional support legs 166a, 166b may be utilized with or without the legs. The support legs 166a, 166b are rotatably coupled to the left and right tubes 156a, 156b, respectively. Advantageously, when the pet ramp 20 is in the stowed state, the rotatable coupling enables the support legs 166a, 166b to be substantially parallel to the left and right tubes 156a, 156b. Likewise, when the pet ramp 20 is in the deployed state, the rotatable couple enables the support legs 166a, 166b to rotate downward toward the ground, such that they can support the weight of a pet utilizing the pet ramp 20. Each support leg 166a, 166b includes a height adjustment mechanism 170 that is configured to fix the length of either the support leg 166a, 166b to which it is attached. In the illustrated embodiment, the height adjustment mechanism 170 utilizes a cam lock mechanism, although functionally similar devices may be utilized in other embodiments. In other embodiments, the support legs 166a, 166b may be mounted on the lower slide assembly 36 instead of the upper slide assembly 32.

Referring still to FIG. 6, the upper slide assembly 32 further includes a plurality of optional guide members 172a, 172b that assist animals utilizing the pet ramp 20 to ascertain the side boundaries of the upper slide assembly 32, the mattress-facing end 84 of the upper slide assembly 32, and/or the mattress 88 through visual identification (especially for vision-impaired pets) and/or through tactile identification when the pet feels the guide member 172 with its paw. The inventors have found that even a small guide member at or near the edge of the upper slide assembly 32 can greatly reduce the likelihood that an animal falls off the pet ramp 20. This is especially true in dark operating environments (e.g., a dark bedroom), when an animal is advanced in age, and/or when an animal has a visual impairment or other handicap. In the illustrated embodiment, guide members 172a, 172b comprise railings having a height of about 2-3 inches that are collapsibly coupled with the left tube 156a and right tube 156b, respectively. In other embodiments, the guide members may have a different height, e.g., as short as about one inch or as tall as about six inches. Likewise, in other embodiments, the guide members may attach to the upper slide assembly 32 in a different manner, e.g., slidably or on a pivotal frame. In some embodiments, the lower slide assembly 36 may additionally or alternatively include guide members.

Still referring to FIG. 6, the lower slide assembly 36 includes a lower pan 174, a left tube 178a, and a right tube 178b. The lower pan 174 serves as a walking surface for pets ingressing/egressing the bed, and is offset below the upper pan 152 such that it can slide into the track formed by the angle brackets 162a, 162b and the bottom side of the upper pan 152. A lower pan bracket 186 spans the tubes 178a and 178b, and provides a base upon which a bottom end of the lower pan 174 is mounted. The lower pan 174 is mounted on the lower pan bracket 186 such that it is spaced apart from both tubes 178a, 178b, thereby leaving a gap on either side of the lower pan 174.

The left and right tubes 178a, 178b of the lower slide assembly 36, along with the lower pan 174, form part of the same telescoping assembly that comprises the upper pan 152 and tubes 156a, 156b of the upper slide assembly 32. In particular, the left tube 156a of the upper slide assembly 32 slidably receives the left tube 178a of the lower slide assembly 36. Likewise, the right tube 156b of the upper slide assembly 32 slidably receives the right tube 178b of the lower slide assembly 36. The lower pan 172 slides of the lower slide assembly 36 slides within the angle brackets 162a, 162b of the upper slide assembly 32. Thus, the lower slide assembly 36 can slide relative to the upper slide assembly 32, to adjust the effect ramp length L of the pet ramp 20.

In use, when a shorter effective ramp length L is desired, a user can push the lower slide assembly 36 toward the upper slide assembly 32. This causes: 1) the lower pan 174 to slide within the track formed by the angle bracket 162a, 162b, 2) the left tube 178a of the lower slide assembly 36 to slide within the left tube 156a of the upper slide assembly 32, and 3) the right tube 178b of the lower slide assembly 36 to slide within the right tube 156b of the upper slide assembly 32. The reverse is true when a user pulls the lower slide assembly 36 away from the upper slide assembly 32. A plurality of slide length locks 190a, 190b are positioned on the left tube 156 and the right tube 160, respectively, such that the slide length L can be locked at the desired length once the pet ramp 20 is placed in its deployed state. In the illustrated embodiment, each of the slide length locks 190a, 190b utilize a cam lock mechanism, although functionally similar devices may be utilized in other embodiments. In other embodiments, the pet ramp 20 may utilized fewer or additional slide length locks, which may have different locations than in the illustrated embodiment.

Any of the walking surfaces of the pet ramp 20—including walking surface of the bridge 124, the upper pan 152, and/or the lower pan 174—may be formed from an enhanced-traction material, may be at least partially treated or processed to have an enhanced-traction texture, and/or may have a layer of enhanced-traction material that partially or completely covers the walking surface, such as a removable and cleanable rubberized and textured mat or carpet. Further, some embodiments may omit carpet entirely, due to undesirable added thickness imparted by carpet.

In the illustrated embodiment, the lower end of the lower slide assembly 36 is fitted with an optional foot 196 having a soft, rubberized, and/or high-friction material, in order to reduce noise and potential damage when the lower slide assembly 36 makes contact with a floor, to increase friction between the lower slide assembly 36 and the floor, or for other advantage. Silicone is a suitable material for the foot 196, although other materials may be suitable. The foot 196 may include one of more grasping portions (e.g., recesses, apertures, protrusions, and/or similar features) that advantageously enable the foot 196 to be used as a handle to pull the lower slide assembly 36 out of the upper slide assembly 32.

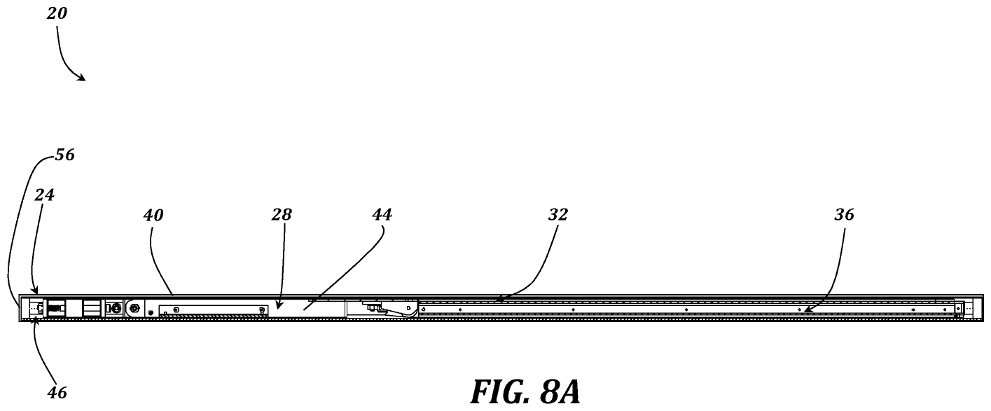

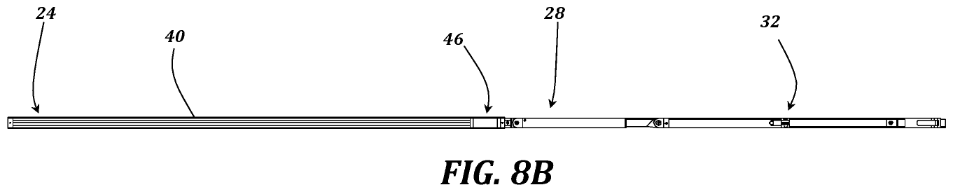

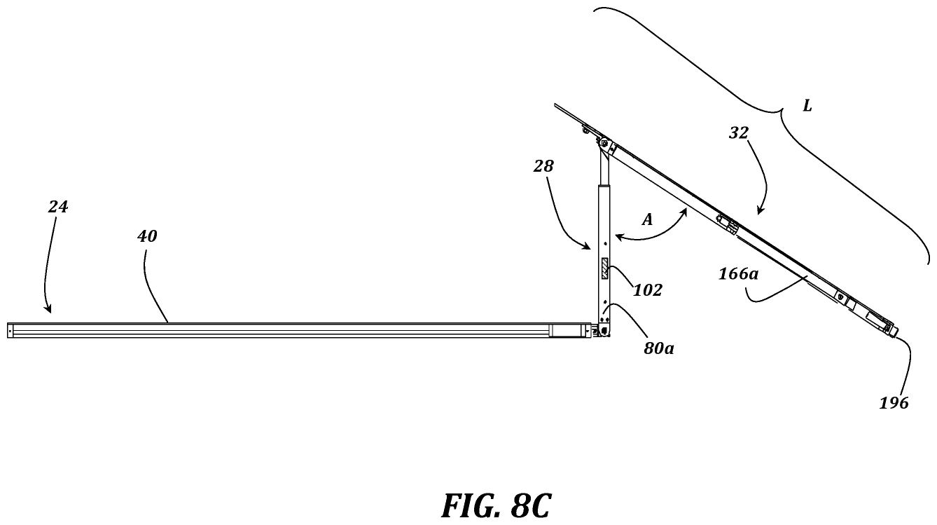

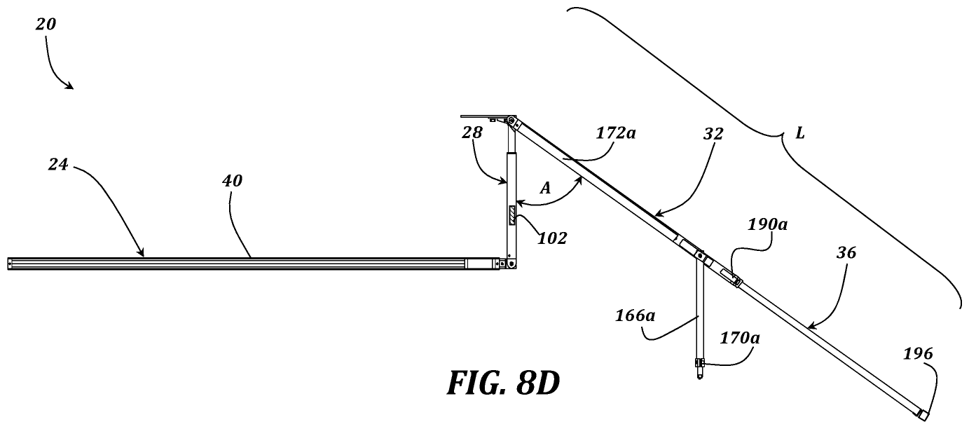

FIGS. 8A-8D show an exemplary method that a person can undertake to manipulate the pet ramp 20 from the stowed state to the deployed state, and vice versa. The following description may refer to elements that are introduced above and shown in FIGS. 1-7, but may not be visible in FIGS. 8A-8D.

FIG. 8A shows a side section view of the pet ramp 20 in the stowed state. In this state, the lower slide assembly 36 is nested underneath the upper slide assembly 32 (as shown in FIG. 5). Further, the support legs 166a, 166b are rotated such that they are substantially parallel to the left and right tubes 156a, 156b. The upper slide assembly 32 and the lower slide assembly 36 are stowed within the pocket 44 formed by the housing 40. Accordingly, the carriage 46 of the housing assembly 24 is pushed toward the rear side 56 of the pocket 44. In this state, the entire pet ramp 20 may be discreetly stowed underneath a mattress, e.g., between a mattress and a box spring.

FIG. 8B shows the pet ramp 20 in a first partially deployed state (with a left side panel of the housing 40 hidden), in which the nested upper slide assembly 32 and lower slide assembly 36 are pulled out from the pocket 44, such that the carriage 46 is located proximal to the opening 68 of the pocket 44 (see FIG. 1).

FIG. 8C shows the pet ramp 20 in a second partially deployed state (with a left side panel of the housing 40 hidden), in which the upper slide assembly 32 and the lower slide assembly 36 are still nested together, but the vertical member assembly 28 is rotated until the height adjustment members 80 are vertical relative to the housing 40 (as shown in FIGS. 1-4). In the illustrated embodiment, the vertical position lock 128 (shown in FIG. 4) is engaged such that the vertical member assembly 28 remains in the vertical position. Locking the vertical member assembly 28 in the vertical position eliminates one degree of freedom in the pet ramp 20, thereby facilitating deployment of the lower slide assembly 36—especially in confined environments. In particular, locking the vertical member assembly 28 in the vertical position prior to adjusting the effective ramp length L facilitates adjustment of the effective ramp length L by reducing the space necessary to make that adjustment. The nested upper slide assembly 32 and lower slide assembly 36 are pivoted relative to the housing 40 in order to create an effective ramp angle A suitable for the space constraints and for the physical capabilities of an animal.

FIG. 8D shows the pet ramp 20 in a fully deployed state (with a left side panel of the housing 40 hidden), in which the lower slide assembly 36 has been pulled out of the upper slide assembly 32 to increase the effective ramp length L. The ramp length L may be adjusted such that the pet ramp 20 has an effective angle A that is not too steep when the foot 196 rests upon the ground. To fix the ramp length L, the user can activate the slide length lock 190a. Optionally, to further secure the pet ramp 20, the user may rotate one or both support legs 166a, 166b into a vertical position and set the height adjustment mechanisms 170a, 170b. As another optional step, the user may deploy one or more guide members 172a, 172b to further increase safety. Following these steps, the pet ramp 20 is ready for use.

Stowage of the pet ramp 20 may be accomplished by executing the above steps in reverse to reconfigure the pet ramp 20 from the deployed stayed to the stowed state. One additional step is the release of the vertical member assembly 28 from the vertical position (or non-vertical locked position, depending on the embodiment). This is accomplished by activating the position release button 102, which is described above with respect to FIGS. 3 and 4.

Although the above steps have been described in a particular sequence, one or more steps may be performed in a different order than described above. In some embodiments, one or more steps may be omitted entirely. For example, a user utilizing a pet ramp 20 that is not equipped with support legs 166a, 166b or guide members 172a, 172b would omit the corresponding steps above. Furthermore, the above actions may be accomplished in greater or fewer steps; the depiction of the deployment sequence in four figures is intended to facilitate understanding, not to limit the scope of the present disclosure.

While illustrative embodiments have been illustrated and described, it will be appreciated that various changes can be made therein without departing from the spirit and scope of the invention.

The embodiments of the invention in which an exclusive property or privilege is claimed are defined as follows:

1. A collapsible ramp that is movable between a stowed state and a deployed state, comprising:
a housing assembly that includes a housing and a movable carriage within the housing, the housing at least partially defining a pocket;
a vertical member assembly having a height adjustment member that is pivotably coupled to the movable carriage;
an upper slide assembly that is pivotably coupled to the height adjustment member; and
a lower slide assembly that is slidably coupled with the upper slide assembly,
wherein the lower slide assembly is configured to reversibly nest within the upper slide assembly within the pocket in the stowed state, and the vertical member assembly is configured to support a ramp formed by the upper slide assembly and the lower slide assembly in the deployed state.

2. The collapsible ramp of claim 1, wherein the housing has a thickness of less than about 1.25 inches.

3. The collapsible ramp of claim 2, wherein the vertical member assembly is configured to reversibly nest within the pocket in the stowed state such that the height adjustment member lies parallel to the upper slide assembly and the lower slide assembly.

4. The collapsible ramp of claim 1, wherein the housing assembly further comprises a plurality of rails that are positioned within the housing and guide movement of the movable carriage.

5. The collapsible ramp of claim 4, wherein in the stowed state, the movable carriage is located near a rear end of the pocket, and in the deployed state, the carriage is located adjacent an opening of the pocket.

6. The collapsible ramp of claim 1, wherein the vertical member assembly comprises a vertical position lock configured to fix the height adjustment member at an angle between about 75 degrees and about 105 degrees relative to the housing.

7. The collapsible ramp of claim 6, wherein the vertical position lock includes a force-biased pin that is configured to engage a slot of the movable carriage of the housing assembly when the height adjustment member is at about a right angle relative to the housing.

8. The collapsible ramp of claim 7, wherein the movable carriage includes a contoured mating surface that is configured to guide the force-biased pin of the vertical position lock.

9. The collapsible ramp of claim 1, wherein the upper slide assembly forms a track that is configured to slidably receive a lower pan of the lower slide assembly.

10. The collapsible ramp of claim 9, wherein the track is configured to slidably receive the lower pan of the lower slide assembly underneath an upper pan of the upper slide assembly.

11. The collapsible ramp of claim 10, wherein the upper slide assembly includes a left tube and a right tube that are configured to slidably receive a left tube and a right tube of the lower slide assembly, respectively.

12. The collapsible ramp of claim 11, further comprising a slide length lock located upon the upper slide assembly that fixes a ramp length of a ramp formed by the upper slide assembly and the lower slide assembly.

13. The collapsible ramp of claim 1, further comprising a plurality of support legs that are movably coupled to the upper slide assembly, each of which has an adjustable height.

14. The collapsible ramp of claim 1, further comprising a bridge that is pivotably connected to a bed-facing end of the upper slide assembly, wherein the bridge is configured to extend away from the upper slide assembly in the deployed state.

15. The collapsible ramp of claim 1, wherein a lower end of the lower slide assembly is fitted with a foot having a soft material.

16. The collapsible ramp of claim 1, wherein a portion of the housing assembly that surrounds an opening of the pocket is covered, coated, treated, or fitted with a soft material.

17. The collapsible ramp of claim 1, wherein the upper slide assembly includes a plurality of retractable guide members, each guide member being configured to provide visual and tactile guidance as to a location of a boundary of the upper slide assembly.

18. A method of using a collapsible pet ramp, comprising:
placing the collapsible pet ramp underneath a mattress;
sliding a collapsible ramp assembly out of a housing of the collapsible pet ramp;
locking a bed-facing end of the collapsible ramp assembly relative to the housing in a position that is gravitationally above the housing;
pivoting the collapsible ramp assembly relative to the housing; and
extending an effective ramp length of the collapsible ramp assembly until the collapsible ramp rests on a ground surface.

19. The method of claim 18, wherein locking the bed-facing end of the collapsible ramp assembly comprises locking a rigid support assembly at between about 75 degrees and about 105 degrees relative to the housing.

20. The method of claim 18, wherein locking the bed-facing end of the collapsible ramp assembly occurs prior to extending the effective ramp length of the collapsible ramp assembly.
